(19) United States
(12) Patent Application Publication
(10) Pub. No.: US 2016/0212982 A1
(43) Pub. Date: Jul. 28, 2016

(54) SYSTEMS AND METHODS FOR ATTRACTING FISH

(71) Applicant: Ken E. Clark, Cape Coral, FL (US)

(72) Inventor: Ken E. Clark, Cape Coral, FL (US)

(21) Appl. No.: 14/997,475

(22) Filed: Jan. 15, 2016

Related U.S. Application Data
(60) Provisional application No. 62/107,570, filed on Jan. 26, 2015.

(51) Int. Cl. A01K 97/00; H02P 25/032; H02P 1/08; H02K 7/06

(52) U.S. Cl. CPC A01K 97/00; H02K 7/061; H02P 25/032; H02P 1/08

(57) ABSTRACT

A device can be configured to couple to a fishing pole. The device can include a housing and an attachment system coupled to the housing. The attachment system can be configured to attach the housing to the fishing pole. The device can also include a resonance generator coupled to the housing. The resonance generator can produce resonance that travels from the housing to the fishing pole through a fishing line to a hook located at a distal end of the fishing line to thereby attract fish towards the hook.

### CROSS-REFERENCE TO RELATED APPLICATIONS

This application claims the benefit of U.S. Provisional Patent Application No. 62/107,570; filed Jan. 26, 2015; and entitled RESONATING DEVICE THAT ATTACHES TO A FISHING POLE FOR CATCHING FISH. The entire contents of U.S. Provisional Patent Application No. 62/107,570 are incorporated herein by reference.

### BACKGROUND

1. Field

The invention is directed, in general to fishing, and more specifically, to systems and methods for attracting fish to a fishing pole.

2. Description of Related Art

Fishing can be performed using a variety of tools. For example, a person can use a fishing pole that includes a baited hook attached to the fishing pole via a fishing line. Fish can be attracted to the baited hook for a variety of reasons. For example, when multiple fish swarm the baited hook, other nearby fish can be attracted towards the baited hook because the nearby fish perceive that a feeding frenzy is occurring. However, unless an actual feeding frenzy is in progress, fishing poles are unable to create the perception of a feeding frenzy. Thus, there is a need for systems and methods to create the perception of a feeding frenzy using a fishing pole.

### SUMMARY

The present disclosure includes systems for attracting fish. In some embodiments, the system includes a housing; an attachment system coupled to the housing, wherein the attachment system is configured to attach the housing to a fishing pole; and a resonance generator coupled to the housing, wherein the resonance generator produces resonance that travels from the housing to the fishing pole through a fishing line to a hook located at a distal end of the fishing line to thereby attract fish towards the hook.

In some embodiments, the system further comprises a circuit board coupled to the housing and electrically coupled to the resonance generator. The circuit board can control a duration and frequency of the resonance emitted by the resonance generator.

As well, in some embodiments, the system further includes a power button coupled to the housing and electrically coupled to the circuit board. When the power button is pressed the system can be powered on or powered off.

Even still, in some embodiments, the system further comprises a plurality of LEDs coupled to the housing. The plurality of LEDs can surround the power button. The plurality of LEDs can be configured to indicate when the resonance generator is activated and deactivated. In some embodiments, the plurality of LEDs comprises four LEDs, and the plurality of LEDs blink when the resonance generator is deactivated.

Furthermore, in some embodiments, the resonance generator comprises a motor. The motor can be selected from the group consisting of a micro vibration motor and a mini vibration motor.

In some embodiments, the system can further comprise a battery coupled to the housing and electrically coupled to the motor such that the battery provides power to the motor. The battery can comprise a 3-volt lithium battery.

As well, in some embodiments, the system further comprises a battery cap threadably coupled to the housing. When the battery cap is coupled to the housing, the battery cap can substantially enclose the battery. When the battery cap is decoupled from the housing, the battery can be slideably removed from the housing.

The present disclosure can also include a system for attracting fish. The system can include a housing; an attachment system coupled to the housing, wherein the attachment system is configured to attach the housing to a fishing pole; and a circuit board coupled to the housing, wherein the circuit board is configured to produce a signal that attracts fish towards the fishing pole.

The system can also include a motor coupled to the housing. The motor can produce resonance that can travel from the housing to the fishing pole through a fishing line to a hook located at a distal end of the fishing line to thereby attract fish towards the hook.

In some embodiments, the motor produces between 11,000 and 16,000 rotations per minute and between 0.94 and 1.10 Gs of acceleration force. As well, in some embodiments, the motor is no greater than 10.8 millimeters in length and 6.1 millimeters in diameter. Even still, the resonance can be between 40 and 1,000 Hz.

The present disclosure also includes a method of attracting fish towards a hook located at a distal end of a fishing line coupled to a fishing pole. The method can include producing resonance via an electronic device coupled to the fishing pole; and causing the resonance to travel from the electronic device to the fishing pole through the fishing line to the hook to thereby attract fish towards the hook.

The electronic device can be coupled to a housing. Accordingly, the method can further include snapably coupling a first portion of the housing to the fishing pole, and locating the housing along the fishing pole such that the electronic device is within 4 inches of a handle of the fishing pole. As well, the method can include snapably coupling a second portion of the housing to the electronic device.

In some embodiments, the method further includes simultaneously flashing an LED located on the electronic device while the electronic device produces the resonance. As well, the method can include pressing a power button on the electronic device for between 1 to 4 seconds to thereby power the electronic device on.

Even still, the method can include automatically powering the electronic device off after no more than five hours. In some embodiments, while the electronic device is powered on, the method can further comprise entering a cycle whereby the electronic device first emits resonance for no more than 5 seconds and then the electronic device stops emitting resonance for no more than 5 seconds. The method can include repeating the cycle at least one more time.

The embodiments described above include many optional features and aspects. Features and aspects of the embodiments can be combined.

### BRIEF DESCRIPTION OF THE DRAWINGS

These and other features, aspects, and advantages are described below with reference to the drawings, which are intended to illustrate, but not to limit, the invention. In the drawings, like reference characters denote corresponding features consistently throughout similar embodiments. The above and other features of the present invention will become more apparent by describing in detail exemplary embodiments thereof with reference to the accompanying drawings, in which:

FIG. 1 illustrates a perspective view of a system for attracting fish coupled to a fishing pole, according to embodiments of the present disclosure;

FIG. 2 illustrates a perspective view of a system for attracting fish decoupled from a fishing pole, according to embodiments of the present disclosure;

FIG. 3 illustrates a perspective exploded view of a system for attracting fish, according to embodiments of the present disclosure;

FIG. 4 illustrates a schematic diagram of a housing, according to embodiments of the present disclosure;

FIG. 5 illustrates a perspective cutaway view of a front cap of the resonating device, according to embodiments of the present disclosure;

FIG. 6 illustrates perspective views of a front cap, housing, and a battery cap, according to embodiments of the present disclosure;

FIG. 7a illustrates a top view of a system for attracting fish, according to embodiments of the present disclosure;

FIG. 7b illustrates a cross-sectional view along line A-A from FIG. 7a, according to embodiments of the present disclosure; and

FIG. 8 illustrates a flow diagram showing methods of operating systems for attracting fish, according to embodiments of the present disclosure.

### DETAILED DESCRIPTION

Although certain embodiments and examples are disclosed below, inventive subject matter extends beyond the specifically disclosed embodiments to other alternative embodiments and/or uses, and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components.

For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

### LIST OF REFERENCE NUMERALS

10—System for attracting fish
12—Housing
14—Attachment system
16—Pole attachment
18—Device attachment
20—Fishing pole
22—Handle
24—Fishing line
26—Hook
28—Resonance generator
28a—Micro vibration motor
28b—Mini vibration motor
30—Circuit board
32—Battery
34—Battery cap
35—Mid housing
36—Front cap
38—Power button
40—Light emitting diode (LED)
42—Ground spring
44—Positive conductor
46—Battery cap O-ring
48—Front cap O-ring
50—Power supply circuit board

### INTRODUCTION

The system for attracting fish 10 (system 10), as disclosed, can address the disadvantages as previously described. For example, embodiments of the system for attracting fish 10 can produce a signal that attracts fish towards a fishing hook 26. In this regard, whether or not an actual feeding frenzy is occurring, the system for attracting fish 10 can produce an on-demand signal that is perceived by the fish as a feeding frenzy in process. This may result in multiple fish swarming and biting onto the hook 26.

### RESONATING DEVICE EMBODIMENTS

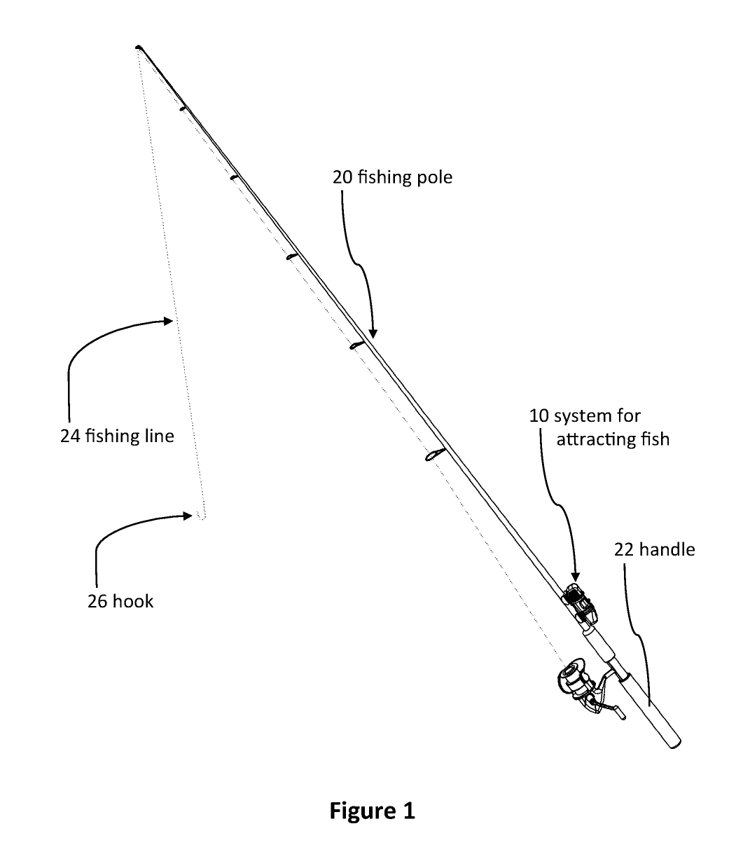

As shown in FIG. 1, the present disclosure includes a system for attracting fish 10 that can be attached to a fishing pole 20, just above a handle 22. The system for attracting fish 10 can include a housing 12 and a resonance generator 28 that can produce vibration, such as resonance. The resonance can travel from the housing 12 to the fishing pole 20 through a fishing line 24 to the hook 26 located at a distal end of the fishing line 24 to thereby attract fish towards the hook 26. It should be appreciated that the resonance can also be referred to as a vibration, a signal, and the like.

Once the resonance travels to the hook 26, the resonance can produce slight turbulence or small waves in the water to thereby create the perception of the feeding frenzy. This perceived feeding frenzy can attract multiple fish to the hook 26, which can increase the odds of a user catching fish via the hook 26. In some embodiments, the resonance defines a frequency in the range of 40 to 1,000 hertz (Hz).

In some embodiments, the resonance generator 28 is a motor, such as a micro vibration motor 28a and/or a mini vibration motor 28b. In some embodiments, the motor defines the following specifications: rated voltage 3.0 volts DC; rated speed minimum 11,000 to 16,000 rpms; rated current 66 to 95 milliamps; starting voltage 1.4 to 2 volts DC; acceleration force 0.94 to 1.10 Gs; overall length 11.8 to 20 millimeters; motor length 8 to 10.8 millimeters; and motor diameter 4.1 to 6.1 millimeters. Generally, it should be appreciated that the resonance generator 28 can be any type of device configured to produce a signal, such as resonance, vibration, and the like. The system 10 can also include a circuit board 30 coupled to the housing 12 and electrically coupled to the resonance generator 28. The circuit board 30 can control the duration and frequency of the resonance emitted by the resonance generator 28. In some embodiments, the resonance generator 28 emits resonance for between 1 millisecond and 5 seconds. As well, the resonance generator 28 can terminate emitting resonance such that the resonance stays off for between 1 second and 5 seconds. In some embodiments, this cycle can repeat itself for between 2 and 10 cycles.

The system 10 can be powered by a battery 32 that can be coupled to the housing 12 and electrically coupled to the resonance generator 28 and the circuit board 30. In this regard, the battery 32 can provide power to the resonance generator 28 and the circuit board 30. In some embodiments, the battery 32 is a 3-volt lithium battery. To preserve battery life, the circuit board 30 can be configured to shut down the system 10 after a prolonged period of use, such as 2 to 5 hours of use.

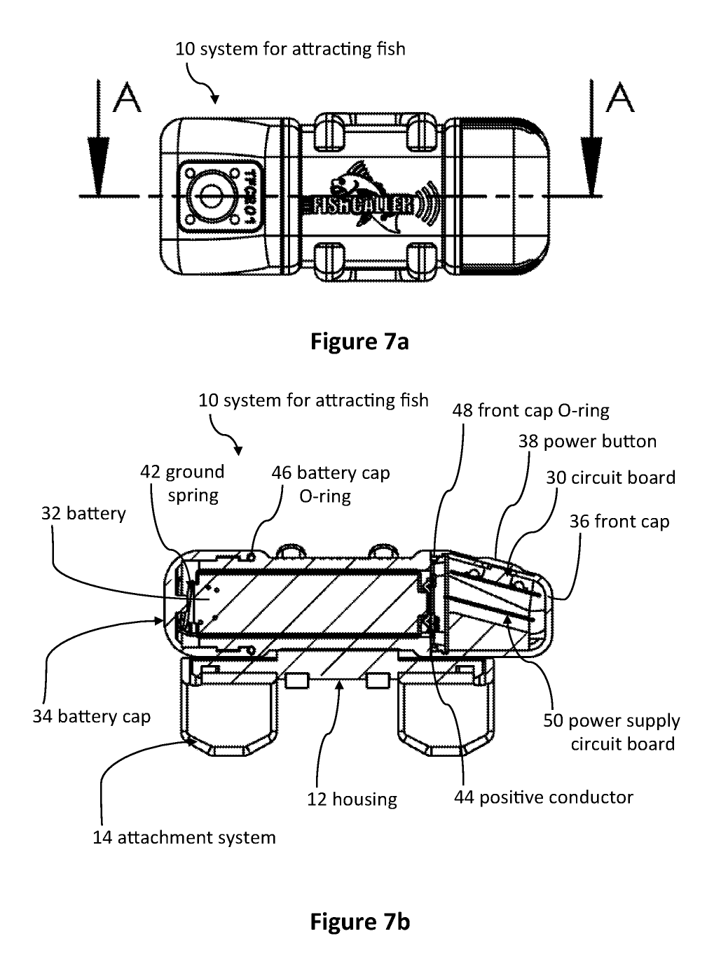

As shown in FIG. 7b, the system for attracting fish 10 can also include a battery cap 34 threadably (e.g. twistably or rotatably) coupled to the housing 12. When both the battery 32 and the battery cap 34 are coupled to the housing 12, the battery cap 34 can substantially enclose the battery 32 from the outside environment. Accordingly, when the battery cap 34 is decoupled from the housing 12, the battery 32 can be slideably removed from the housing 12. It should be appreciated that the battery cap 34 can be coupled to the housing 12, specifically the mid housing 35, via any type of suitable mechanical connection. In this regard, the battery cap 34 can be coupled via rotation, friction, adhesion, and the like.

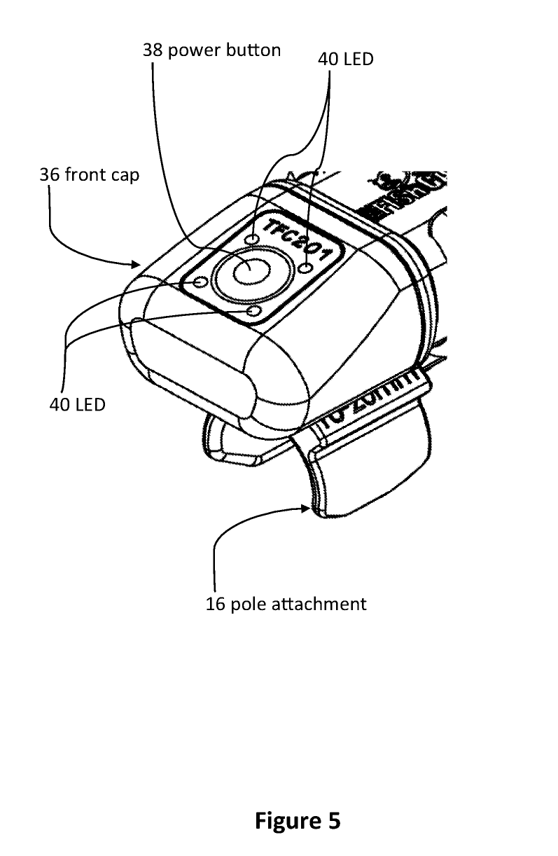

As shown in FIG. 5, the system 10 can include a power button 38 coupled to the housing 12 and electrically coupled to the resonance generator 28, circuit board 30, and battery 32. When the power button 38 is pressed the system 10 can be powered on or powered off. In some embodiments, the power button 38 must be pressed down for a period of between 1 second and 4 seconds to thereby power on or power off the system 10.

The system 10 can further comprise a plurality of light emitting diodes (LEDs) 40 coupled to the housing 12, such as along the front cap 36. In some embodiments, the plurality of LEDs 40 surround the power button 38. However, it should be appreciated that the LEDs 40 can be arranged and configured in any pattern or location on the housing 12. In some embodiments, when the power button 38 is pressed, the plurality of LEDs 40 are configured to illuminate (e.g. blink) to thereby indicate when the resonance generator 28 is activated and/or deactivated. In this regard, the plurality of LEDs 40 can indicate when the system 10 is powered on, powered off, in use, idle, and any various state of operation.

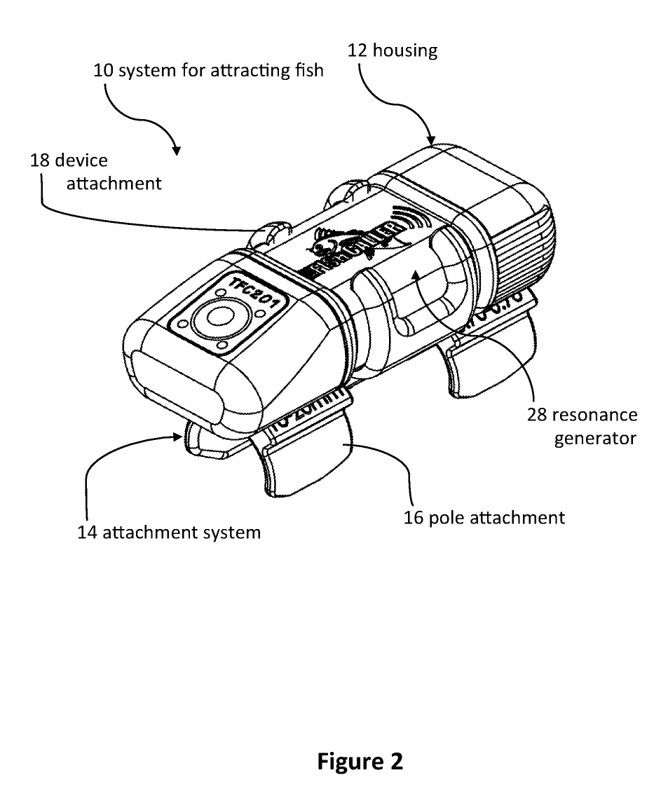

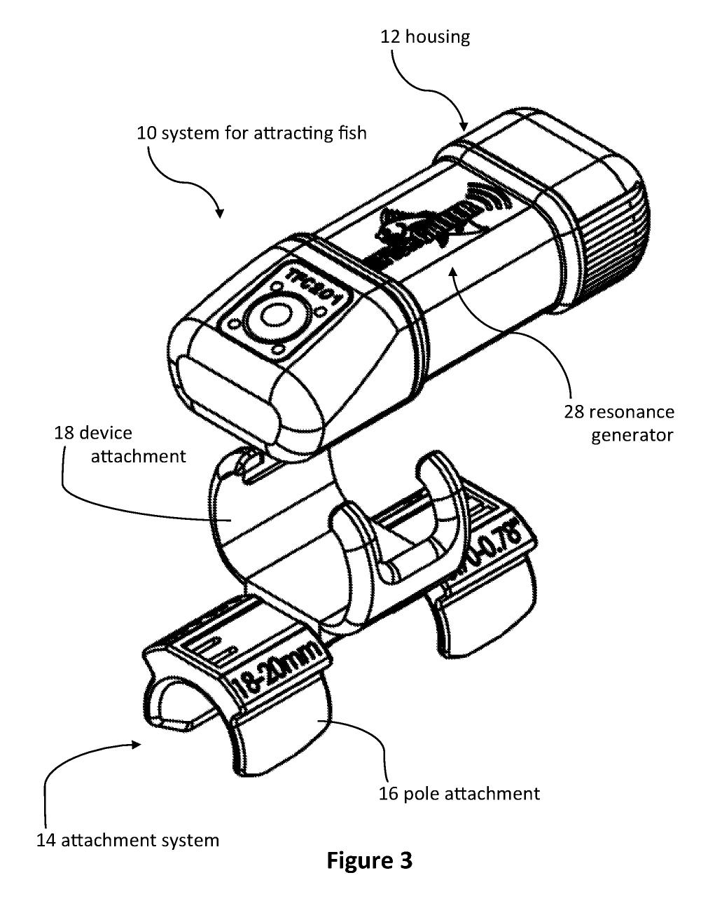

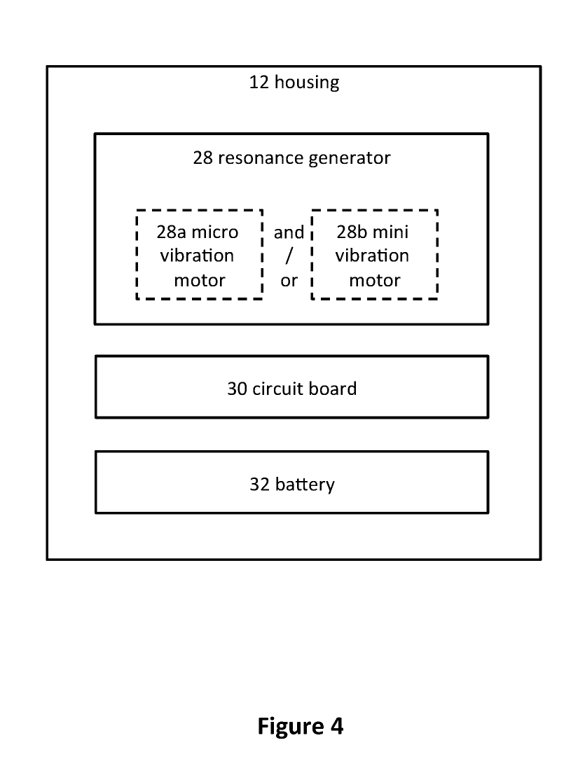

As shown in FIGS. 2 and 3, the system for attracting fish 10 can include an attachment system 14 coupled to the housing 12, which can further be coupled to the fishing pole 20. In some embodiments, the attachment system 14 is separate from the housing 12. However, in other embodiments, the attachment system 14 is contiguous with the housing 12, meaning the attachment system 14 and the housing 12 are formed out of the same piece. In embodiments where the attachment system 14 is a separate piece from the housing 12, the attachment system 14 can further include a pole attachment 16 and a device attachment 18. Accordingly, the attachment system 14 can be coupled (e.g. attached) to the housing 12 via the device attachment 18. Furthermore, the attachment system 14 can be configured to couple the housing 12 to the fishing pole 20, via the pole attachment 16.

The pole attachment 16 and the device attachment 18 can employ various attachment means to couple the attachment system 14 to the fishing pole 20 and the housing 12, respectively. In some embodiments, as shown in FIGS. 2 and 3, the attachment means include a clip fit, snap fit, clamp fit, and/or any type of mechanical fit whereby the pole attachment 16 and the device attachment 18 securely attach or couple onto the fishing pole 20 and the housing 12, respectively. However, it should be appreciated that any type of attachment means that can mechanically or adhesively attach the attachment system 14 to the fishing pole 20 and the housing 12, respectively, can be used.

The system for attracting fish 10 can be configured to attach to a variety of sizes of fishing poles 20. For example, the system 10 can be configured to attach to children's fishing poles all the way up to any size of fishing pole used for recreational or deep-sea fishing. In some embodiments, the clip fit of the pole attachment 16 comprises clips that range from 7.5 millimeters to 18 millimeters.

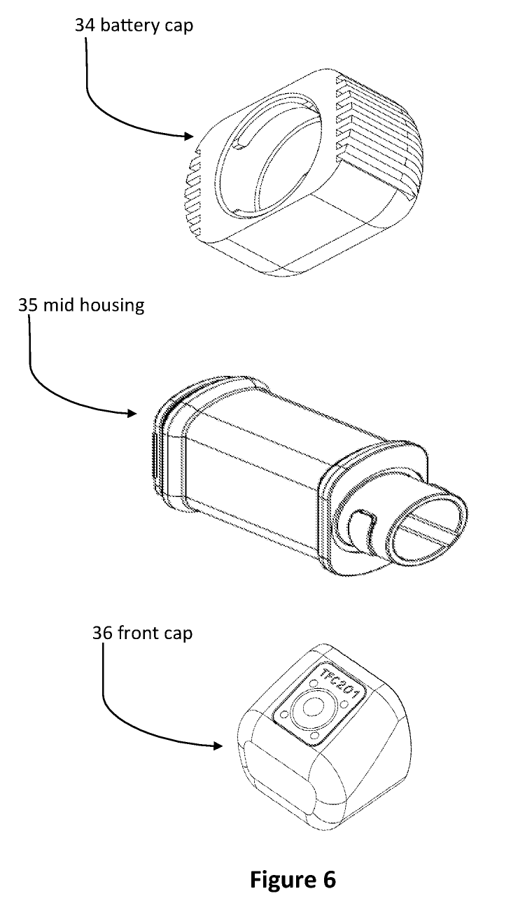

As illustrated in FIG. 6, in some embodiments, the housing 12 can comprise three separate pieces, including the battery cap 34, the mid housing 35, and the front cap 36. These three pieces can be coupled together via various attachment means such as friction fit, snap fit, compression fit, and/or any type of adhesive attachment.

The housing 12 and attachment system 14 can comprise any type of thermo plastic resin and/or polymer. For example, the housing 12 and attachment system 14 can comprise any combination of Acrylonitrile Butadiene Styrene (ABS), nylon, nylon with glass fiber, and nylon with carbon fiber. Generally, it should be appreciated that the housing 12 and attachment system 14 can comprise any type of material that is flexible and provides durability for a secure mechanical fit.

According to FIG. 7a, a top view of the system for attracting fish 10 is shown. FIG. 7a is intended to illustrate line A-A that passes approximately through the middle of the system 10. Accordingly, FIG. 7b shows a cross-sectional view along line A-A from FIG. 7a. The illustration shown in FIG. 7b is intended to show the interior location of various components within the housing 12, according to some embodiments. As shown in FIG. 7b, the circuit board 30 can be located within the front cap 36 of the housing 12, just below the power button 38 and above the power supply circuit board 50. The battery 32 can be located within the housing 12 whereby it is electrically coupled to the ground spring 42 and the positive conductor 44. The battery 32 can thereby be electrically coupled through the ground spring 42 and the positive conductor 44 to the circuit board 30 and the power supply circuit board 50.

The housing 12 can include various sealing mechanisms, such as O-rings, that can prevent moisture, dust, and other toxins from entering the housing 12. As further shown in FIG. 7b, the battery cap 34 can include a battery cap O-ring 46 that can seal the space around the distal edge of the battery 32 to protect the battery 32 from environmental contaminants, as listed above. As well, the front cap 36 can include a front cap O-ring 48 that can protect components, such as the circuit board 30, etc., located at the front of the system 10.

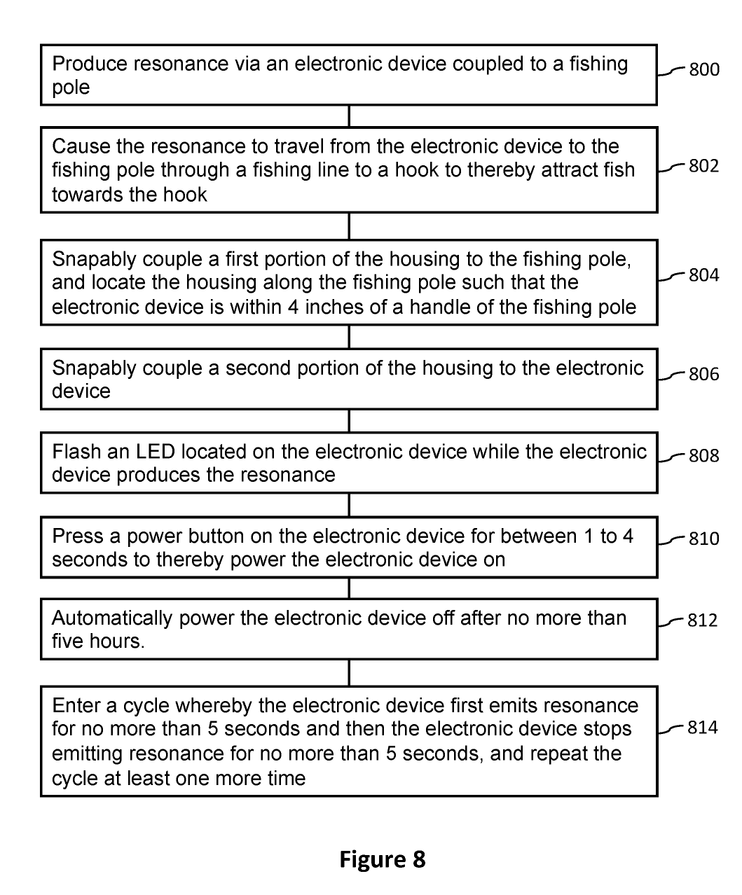

As shown in FIG. 8, the disclosure also includes a method of attracting fish towards a hook 26 located at a distal end of a fishing line 24 coupled to a fishing pole 20. In some embodiments, the method includes producing resonance via an electronic device coupled 28 to the fishing pole 20 (at step 800). As well, methods can include causing the resonance to travel from the electronic device 28 to the fishing pole 20 through the fishing line 24 to the hook 26 to thereby attract fish towards the hook 26 (at step 802).

In some embodiments, the electronic device 28 is coupled to the housing 12. In this regard, methods can further include snapably coupling a first portion of the housing 12 to the fishing pole 20 and locating the housing 12 along the fishing pole 20 such that the electronic device 28 is within 4 inches of the handle 22 of the fishing pole 20 (at step 804). However, in some embodiments, the electronic device 28 can be located any distance from the handle 22, such as within 24 inches, 12 inches, 6 inches, and even within 1 inch. FIG. 8 also shows that the method can include snapably coupling a second portion of the housing 12 to the electronic device 28 (step 806).

With continued reference to FIG. 8, methods can also include simultaneously flashing an LED 40 located on the electronic device 28 while the electronic device 28 produces the resonance (at step 808). As well, the method can even include pressing a power button 38 on the electronic device 28 for between 1 to 4 seconds to thereby power the electronic device 28 on (at step 810). To preserve battery life, the method can include automatically powering the electronic device 28 off after no more than five hours (at step 812).

In some embodiments, while the electronic device 28 is powered on, the method can further include the step of entering a cycle whereby the electronic device 28 first emits resonance for no more than 5 seconds and then the electronic device 28 stops emitting resonance for no more than 5 seconds. Methods can include repeating the cycle at least one more time (at step 814). In some embodiments, the method repeats the cycle up to 10 times.

### INTERPRETATION

None of the steps described herein is essential or indispensable. Any of the steps can be adjusted or modified. Other or additional steps can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

The section headings and subheadings provided herein are nonlimiting. The section headings and subheadings do not represent or limit the full scope of the embodiments described in the sections to which the headings and subheadings pertain. For example, a section titled “Topic 1” may include embodiments that do not pertain to Topic 1 and embodiments described in other sections may apply to and be combined with embodiments described within the “Topic 1” section.

Some of the devices, systems, embodiments, and processes use computers. Each of the routines, processes, methods, and algorithms described in the preceding sections may be embodied in, and fully or partially automated by, code modules executed by one or more computers, computer processors, or machines configured to execute computer instructions. The code modules may be stored on any type of non-transitory computer-readable storage medium or tangible computer storage device, such as hard drives, solid state memory, flash memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and subcombinations are intended to fall within the scope of this disclosure. In addition, certain method, event, state, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments include A, B, and C. The term “and/or” is used to avoid unnecessary redundancy.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein.

The following is claimed:

1. A system for attracting fish, comprising:
a housing;
an attachment system coupled to the housing, wherein the attachment system is configured to attach the housing to a fishing pole; and
a resonance generator coupled to the housing, wherein the resonance generator produces resonance that travels from the housing to the fishing pole through a fishing line to a hook located at a distal end of the fishing line to thereby attract fish towards the hook.

2. The system of claim 1, further comprising a circuit board coupled to the housing and electrically coupled to the resonance generator, wherein the circuit board controls a duration and frequency of the resonance emitted by the resonance generator.

3. The system of claim 2, further comprising a power button coupled to the housing and electrically coupled to the circuit board, wherein when the power button is pressed the system is powered on or powered off.

4. The system of claim 3, further comprising a plurality of LEDs coupled to the housing, wherein the plurality of LEDs surround the power button, and wherein the plurality of LEDs are configured to indicate when the resonance generator is activated and deactivated.

5. The system of claim 4, wherein the plurality of LEDs comprises four LEDs, and wherein the plurality of LEDs blink when the resonance generator is deactivated.

6. The system of claim 2, wherein the resonance generator comprises a motor selected from the group consisting of a micro vibration motor and a mini vibration motor.

7. The system of claim 6, further comprising a battery coupled to the housing and electrically coupled to the motor such that the battery provides power to the motor.

8. The system of claim 7, wherein the battery comprises a 3-volt lithium battery.

9. The system of claim 7, further comprising a battery cap threadably coupled to the housing, wherein when the battery cap is coupled to the housing, the battery cap substantially encloses the battery, and wherein when the battery cap is decoupled from the housing, the battery is able to be slideably removed from the housing.

10. A system for attracting fish, comprising:
a housing;
an attachment system coupled to the housing, wherein the attachment system is configured to attach the housing to a fishing pole; and
a circuit board coupled to the housing, wherein the circuit board is configured to produce a signal that attracts fish towards the fishing pole.

11. The system of claim 10, further comprising a motor coupled to the housing, wherein the motor produces resonance that travels from the housing to the fishing pole through a fishing line to a hook located at a distal end of the fishing line to thereby attract fish towards the hook.

12. The system of claim 11, wherein the motor produces between 11,000 and 16,000 rotations per minute and between 0.94 and 1.10 Gs of acceleration force.

13. The system of claim 12, wherein the motor is no greater than 10.8 millimeters in length and 6.1 millimeters in diameter.

14. The system of claim 11, wherein the resonance is between 40 and 1,000 Hz.

15. A method of attracting fish towards a hook located at a distal end of a fishing line coupled to a fishing pole, the method comprising:
producing resonance via an electronic device coupled to the fishing pole; and
causing the resonance to travel from the electronic device to the fishing pole through the fishing line to the hook to thereby attract fish towards the hook.

16. The method of claim 15, wherein the electronic device is coupled to a housing, the method further comprising:
snapably coupling a first portion of the housing to the fishing pole, and locating the housing along the fishing pole such that the electronic device is within 4 inches of a handle of the fishing pole; and
snapably coupling a second portion of the housing to the electronic device.

17. The method of claim 15, further comprising simultaneously flashing an LED located on the electronic device while the electronic device produces the resonance.

18. The method of claim 15, further comprising pressing a power button on the electronic device for between 1 to 4 seconds to thereby power the electronic device on.

19. The method of claim 17, further comprising automatically powering the electronic device off after no more than five hours.

20. The method of claim 17, while the electronic device is powered on, the method further comprising:
entering a cycle whereby the electronic device first emits resonance for no more than 5 seconds and then the electronic device stops emitting resonance for no more than 5 seconds; and
repeating the cycle at least one more time.
